(19) United States
(12) Patent Application Publication
(10) Pub. No.: US 2017/0053370 A1
(43) Pub. Date: Feb. 23, 2017

(54) SYSTEM AND METHODS FOR ARRANGING GROUND TRANSPORTATION FOR A DEBARKING AIR TRAVELER BASED ON CURB ARRIVAL TIME

(71) Applicant: Charles OGILVIE, Palm Desert, CA (US)

(72) Inventor: Charles OGILVIE, Palm Desert, CA (US)

(21) Appl. No.: 15/225,605

(22) Filed: Aug. 1, 2016

Related U.S. Application Data
(60) Provisional application No. 62/200,503, filed on Aug. 3, 2015.

(51) Int. Cl. G06Q 50/30; G06Q 10/10; G01S 19/13; G06Q 10/02; G01C 21/20; G06Q 50/14; H04L 29/06

(52) U.S. Cl. CPC G06Q 50/30; G06Q 50/14; G06Q 10/1093; H04L 67/42; G06Q 10/025; G01C 21/20; G01S 19/13

(57) ABSTRACT

Systems and methods for arranging ground transportation for a debarking air traveler based on a curb arrival time is disclosed. In one embodiment, the system comprises a server with a processing unit coupled to a memory unit and a server communication unit, wherein the processing unit is programed to receive GPS coordinates from at least one of a GPS unit of a traveler client device and an in-flight locational unit of an aircraft carrying the air traveler; calculate a curb arrival time of the air traveler using an arrival estimation algorithm, wherein the arrival estimation algorithm uses as an input at least one of the GPS coordinates, an aircraft landing signal, and a map of an arriving airport; and transmit the curb arrival time of the air traveler to at least one of a ride-sharing server and a driver client device.

This application claims the benefit of U.S. Provisional Application No. 62/200,503, filed Aug. 3, 2015, which is hereby incorporated by reference in its entirety.

### BACKGROUND OF THE INVENTION

Technical Field

This disclosure relates generally to the field of transportation logistics, more specifically, to computer-implemented systems and methods for arranging ground transportation for a debarking air traveler based on curb arrival time.

Background

Portable client devices such as smartphones, tablets, laptops, and smartwatches are providing increasing levels of functionality for air travelers such as airline passengers and crew. By using such portable devices, air travelers can now check the status of incoming or outgoing flights while on the go. However, the estimated arrival time of an incoming aircraft is often not a sufficient proxy for predicting when a passenger on such an aircraft will arrive at the curb of the arriving airport.

Current tools for predicting the arrival time of an aircraft often do not extend to predicting the curb arrival time of a passenger debarking from the aircraft. The lack of effective tools for predicting such curb arrival times also makes arranging outbound ground transportation for debarking passengers all the more difficult. Therefore, a solution is needed for a system and method to accurately and efficiently arrange ground transportation for an airline passenger based on such passenger's curb arrival time.

In addition, such a solution should take into account the operational and physical differences between the various types of airports in a certain country or locale. Moreover, such a solution should also be sensitive to the type of traveler being tracked and any peculiar travel habits exhibited by the traveler. Furthermore, such a solution should be compatible with different types of portable client devices and also allow third parties to take advantage of the system's benefits and integrate such benefits into their own third party services or platforms.

### SUMMARY

Systems and methods for arranging ground transportation for a debarking air traveler based on the curb arrival time of the air traveler are disclosed.

In one embodiment, a system to arrange ground transportation for an air traveler comprises a server having a processing unit coupled to a memory unit and a server communication unit, wherein the processing unit can be programed to receive GPS coordinates from at least one of a GPS unit of a traveler client device, a position fix from an onboard radio of the traveler client device, and an in-flight locational unit of an aircraft carrying the air traveler. The processing unit can also be programmed calculate a curb arrival time of the air traveler using an arrival estimation algorithm. The arrival estimation algorithm can use as an input at least one of the GPS coordinates, an aircraft landing signal, and a map of an arriving airport. The processing unit can also be programmed to transmit the curb arrival time of the air traveler to at least one of a ride-sharing server, a ground transportation provider server, a driver client device, and a ground transportation worker device.

In another embodiment, a non-transitory machine readable medium is disclosed. The non-transitory machine readable medium comprises instructions stored thereon, wherein the instructions are executable by a processing unit and include the steps of receiving, at a server comprising the processing unit, GPS coordinates from at least one of a GPS unit of a traveler client device and an in-flight locational unit of an aircraft carrying the air traveler. The instructions can also include calculating, at the server, a curb arrival time of the air traveler using an arrival estimation algorithm. The arrival estimation algorithm can use as an input at least one of the GPS coordinates, an aircraft landing signal, and a map of an arriving airport. The instructions can also include transmitting, from the server, the curb arrival time of the air traveler to at least one of a ride-sharing server and a driver client device.

The methods, devices, or systems disclosed herein may be implemented in a variety of different ways. Certain embodiments have other steps or elements in addition to or in place of those mentioned above. The steps or elements will become apparent to those skilled in the art from the accompanying drawings or from the detailed description that follows.

### BRIEF DESCRIPTION OF THE DRAWINGS

FIG. 1 illustrates an embodiment of a system for arranging ground transportation for an air traveler.

FIG. 2A illustrates an embodiment of a server of the system of FIG. 1.

FIG. 2B illustrates an embodiment of a client device of the system of FIG. 1.

FIG. 3 illustrates an embodiment of a method of operation of the system of FIG. 1.

FIG. 4 illustrates embodiments of a step of the method of FIG. 3.

FIG. 5 illustrates an embodiment of a transportation booking graphical user interface (GUI) displayed on a traveler client device.

FIG. 6A illustrates an embodiment of a traveler deplaning GUI displayed on the traveler client device.

FIG. 6B illustrates an embodiment of a baggage claim GUI displayed on the traveler client device.

FIG. 6C illustrates an embodiment of a customs GUI displayed on the traveler client device.

### DETAILED DESCRIPTION OF THE INVENTION

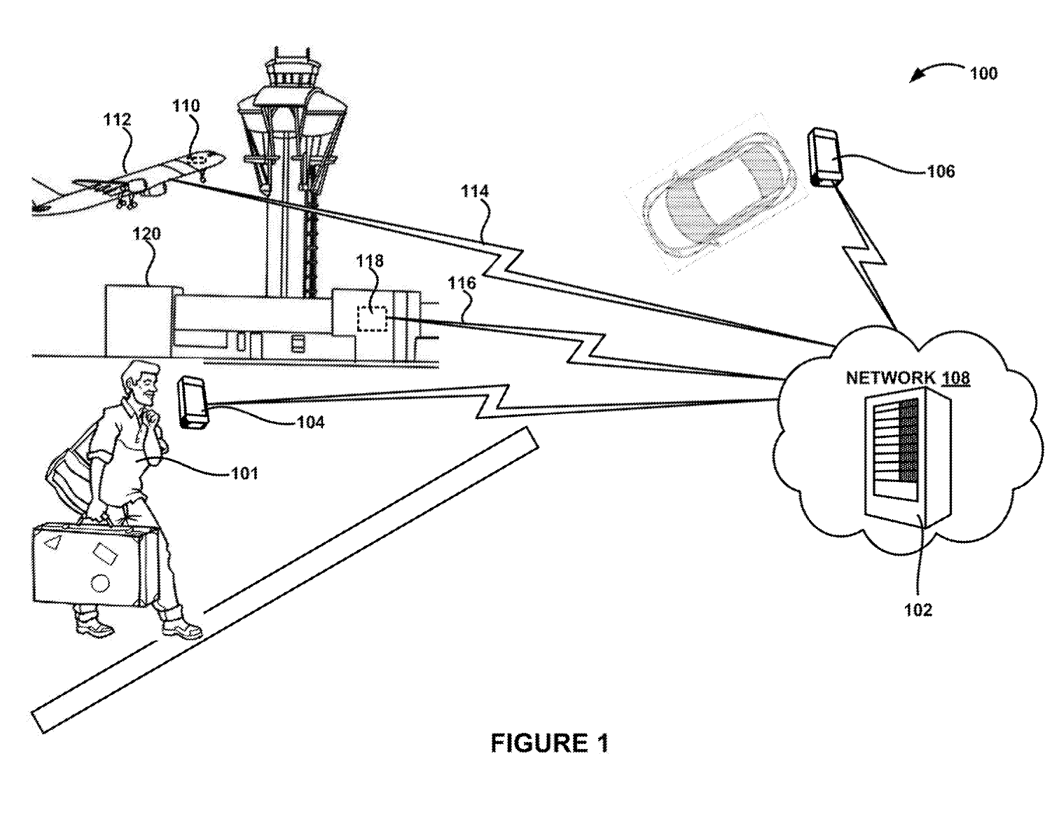

FIG. 1 illustrates an embodiment of a system 100 for arranging ground transportation for an air traveler 101. The system 100 can include a server 102 wirelessly connected to a traveler client device 104, a driver client device 106, or a combination thereof through a network 108. The network 108 can include a cellular network such as a 3G network, a 4G network, or along-term evolution (LTE) network, a satellite network, a WiFi network established under the IEEE's 802.11 protocol, a portion therein, or a combination thereof.

The server 102 can be a centralized server or a de-centralized server. For example, the server 102 can be a cloud server, a cluster server, a part of a server farm, or a combination thereof. The server 102 can be a rack mounted server, a blade server, a mainframe, a dedicated desktop or laptop computer, or a combination thereof. The server 102 can be a virtualized computing resource, a grid computing resource, a peer-to-peer distributed computing resource, or a combination thereof. The server 102 can be any computing device configured to execute a server-side programming language such as PHP, Node.JS, Python, Clojure, Java, Ruby, C++, C, or a combination thereof.

The traveler client device 104 or the driver client device 106 can be a portable computing device such as a smartphone, a tablet, a laptop, a smartwatch, a personal entertainment device, or a combination thereof. For example, the traveler client device 104, the driver client device 106, or a combination thereof can be an iOS™ device, an Android™ device, a Windows™ device, a Blackberry™ device, a Samsung™ Tizen™ device, or a combination thereof.

While FIG. 1 depicts an embodiment using one instance of each of the server 102, the traveler client device 104, and the driver client device 106, it should be understood by one of ordinary skill in the art that the system 100 can include a plurality of servers 102, traveler client devices 104, and driver client devices 106.

The server 102 can also be wirelessly connected to an in-flight locational unit 110 of an aircraft 112 transporting the air traveler 101. The server 102 can receive GPS coordinates of the aircraft 112 from the in-flight locational unit 110 through an aerospace data transfer protocol 114. In one embodiment, the aerospace data transfer protocol 114 can be an AIRINC 429 data transfer protocol.

The server 102 can also receive a beacon signal 116 from a transmitter 118 located in an arriving airport 120. The beacon signal 116 can be a Bluetooth™ signal, a Bluetooth™ Low Energy (BLE) signal, an infrared signal, a near field communication (NEC) signal, or a combination thereof. The transmitter 118 can be a Bluetooth™ transmitter, an optical transmitter, a radio transmitter, or a combination thereof. The server 102 can also receive a radio triangulation signal from the traveler client device 104, a hotspot identification signal from a wireless local area network (WLAN) hotspot located in the arriving airport 120, and a sensor data from an inertial measurement unit of the traveler client device 104.

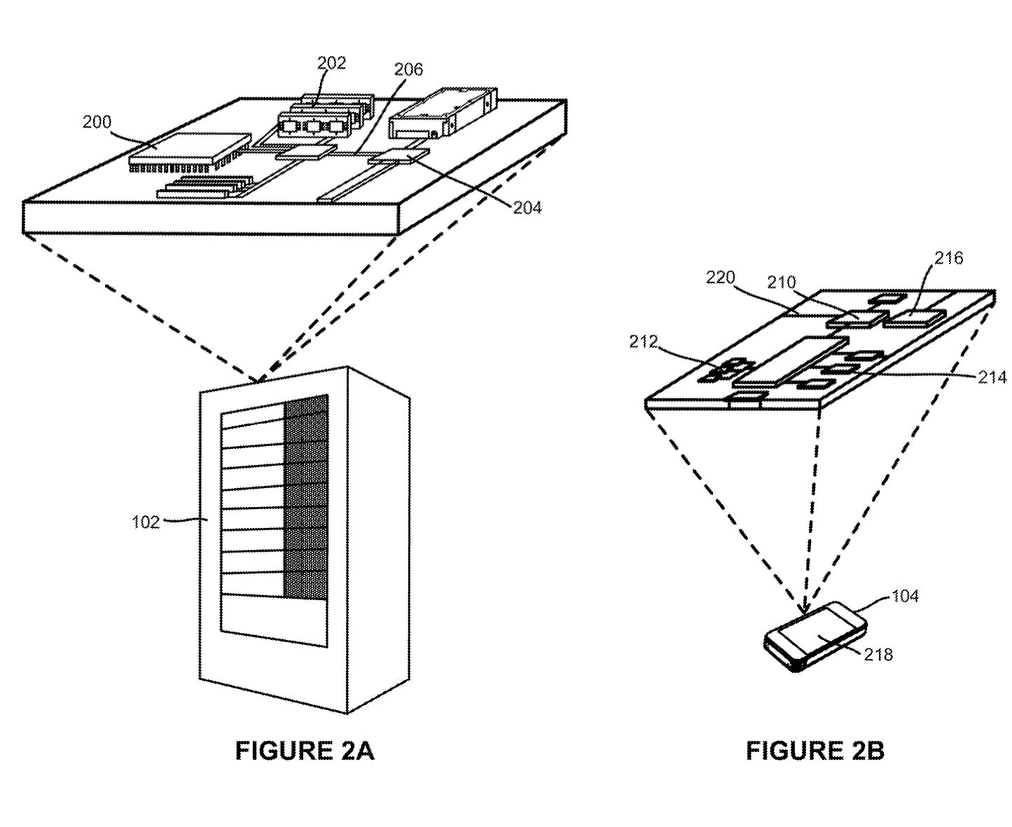

FIG. 2A illustrates an embodiment of the server 102 of the system 100. The server 102 can have a processing unit 200, a memory unit 202, and a server communication unit 204. The processing unit 200 can be coupled to the memory unit 202 and the server communication unit 204 through high-speed buses 206.

The processing unit 200 can include one or more central processing units (CPUs), graphical processing units (GPUs), Application-Specific Integrated Circuits (ASICs), field-programmable gate arrays (FPGAs), or a combination thereof. The processing unit 200 can execute software stored in the memory unit 202 to execute the methods described herein. The processing unit 200 can be implemented in a number of different manners. For example, the processing unit 200 can be an embedded processor, a processor core, a microprocessor, a logic circuit, a hardware finite state machine (FSM), a digital signal processor (DSP), or a combination thereof. As a more specific example the processing unit 200 can be a 64-bit processor.

The memory unit 202 can store software, data, logs, or a combination thereof. The memory unit 202 can be an internal memory. Alternatively, the memory unit 202 can be an external memory, such as a memory residing on a storage node, a cloud server, or a storage server. The memory unit 202 can be a volatile memory or a non-volatile memory. For example, the memory unit 202 can be a nonvolatile storage such as non-volatile random access memory (NVRAM), Flash memory, disk storage, or a volatile storage such as static random access memory (SRAM). The memory unit 202 can be the main storage unit for the server 102.

The server communication unit 204 can include one or more wired or wireless communication interfaces. For example, the server communication unit 204 can be a network interface card of the server 102. The server communication unit 204 can be a wireless modem or a wired modem. In one embodiment, the server communication unit 204 can be a WiFi modem. In other embodiments, the server communication unit 204 can be a 3G modem, a 4G modem, an LTE modem, a Bluetooth™ component, a radio receiver, an antenna, or a combination thereof. The server 102 can connect to or communicatively couple with the network 108 using the server communication unit 204. The server 102 can transmit or receive packets or messages using the server communication unit 204.

FIG. 2B illustrates an embodiment of a client device of the system 100 such as the traveler client device 104 or the driver client device 106. The client device can have a client processor 210, a client memory 212, a client communication unit 214, a locational unit having a global positioning system (GPS) receiver 216, and a display 218. The client processor 210 can be coupled to the client memory 212, the client communication unit 214, and the locational unit through high-speed buses 220.

The client processor 210 can include one or more CPUs, GPUs, ASICs, FPGAs, or a combination thereof. The client processor 210 can execute software stored in the client memory 212 to execute the methods described herein. The client processor 210 can be implemented in a number of different manners. For example, the client processor 210 can be an embedded processor, a processor core, a microprocessor, a logic circuit, a hardware FSM, DSP, or a combination thereof. As a more specific example the client processor 210 can be a 32-bit processor such as an ARM™ processor.

The client memory 212 can store software, data, logs, or a combination thereof. In one embodiment, the client memory 212 can be an internal memory. In another embodiment, the client memory 212 can be an external storage unit. The client memory 212 can be a volatile memory or a non-volatile memory. For example, the client memory 212 can be a nonvolatile storage such as NVRAM, Flash memory, disk storage, or a volatile storage such as SRAM. The client memory 212 can be the main storage unit for the client device.

The client communication unit 214 can be a wired or wireless communication interface. For example, the client communication unit 214 can be a network interface card of the client device. The client communication unit 214 can be a wireless modem or a wired modem. In one embodiment, the client communication unit 214 can be a WiFi modem. In other embodiments, the client communication unit 214 can be a 3G modem, a 4G modem, an LTE modem, a Bluetooth™ component, a radio receiver, an antenna, or a combination thereof. The client device 208 can connect to or communicatively couple with the network 108 using the client communication unit 214. The client device 208 can transmit or receive packets or messages using the client communication unit 214.

The locational unit can have a GPS component such as the GPS receiver 216, an inertial unit, a magnetometer, a compass, or any combination thereof. The GPS receiver 216 can receive GPS signals from a GPS satellite. The inertial unit can be implemented as a multi-axis accelerometer including a three-axis accelerometer, a multi-axis gyroscope including a three-axis MEMS gyroscope, or a combination thereof.

The display 218 can be a touchscreen display such as a liquid crystal display (LCD), a thin film transistor (TFT) display, an organic light-emitting diode (OLED) display, or an active-matrix organic light-emitting diode (AMOLED) display. In certain embodiments, the display 218 can be a retina display, a haptic touchscreen, or a combination thereof. For example, when the client device 208 is a smartphone, the display 218 can be the touchscreen display of the smartphone.

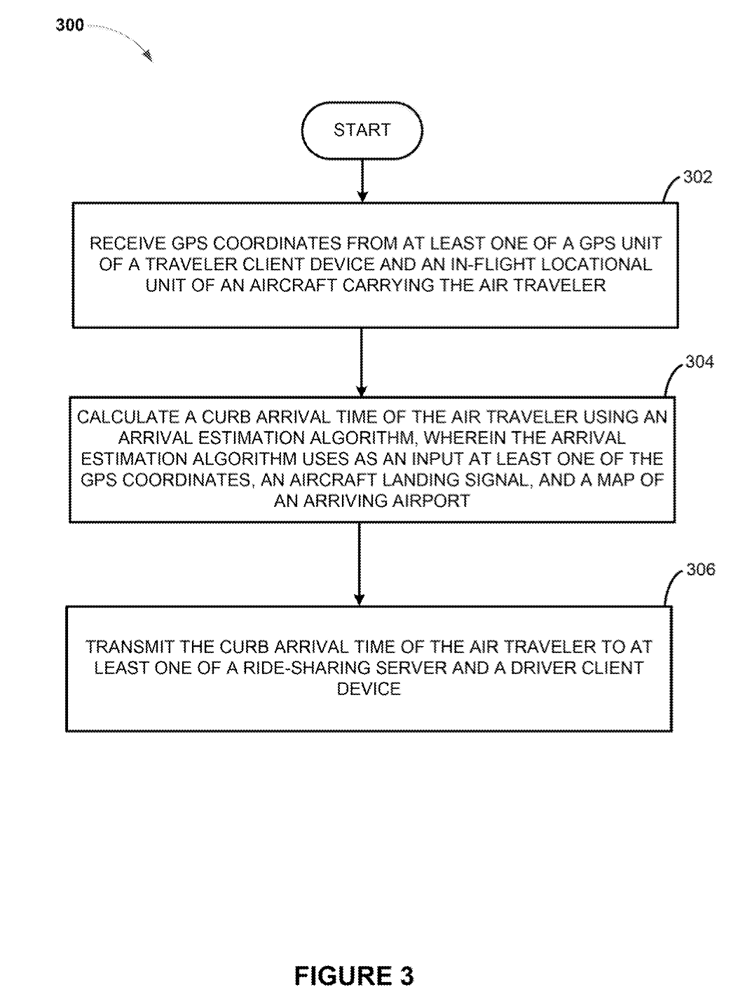

FIG. 3 illustrates a method 300 of operation of the system 100. The method 300 can include receiving, at the server 102, GPS coordinates from at least one of the GPS receiver 216 of the traveler client device 104 and the in-flight locational unit 110 of the aircraft 112 carrying the air traveler 101 in a step 302. The GPS coordinates can be received in response to a user input applied to a display of an inflight seatback console. In one embodiment, the inflight seatback console can be part of a seatback entertainment device. The server 102 can also receive the GPS coordinates from a position fix obtained by an onboard radio of the traveler client device 104. The server 102 can also receive the GPS coordinates of the aircraft 112 through an aerospace data transfer protocol 114 such as the AIRINC 429 data transfer protocol.

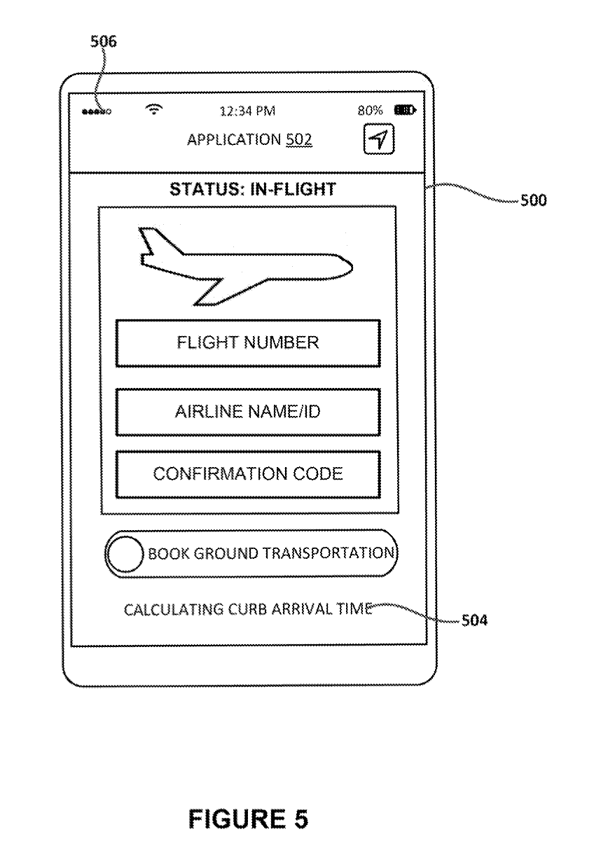

The method 300 can also include calculating, at the server 102, a curb arrival time 504 (see FIG. 5) of the air traveler 101 in a step 304 using an arrival estimation algorithm, wherein the arrival estimation algorithm uses as an input at least one of the GPS coordinates, an aircraft landing signal, and a map of the arriving airport 120. The aircraft landing signal can include an aircraft weight-on-wheels hardware discrete read, an aircraft door-open hardware discrete read, an aircraft parking brake discrete read, or a combination thereof.

The method 300 can further include transmitting, from the server 102, the curb arrival time 504 of the air traveler 101 to at least one of a ride-sharing server and the driver client device 106. The server 102 can transmit the curb arrival time 504 of the air traveler 101 through the network 108. The ride-sharing server can be a server of a ride-sharing platform or service.

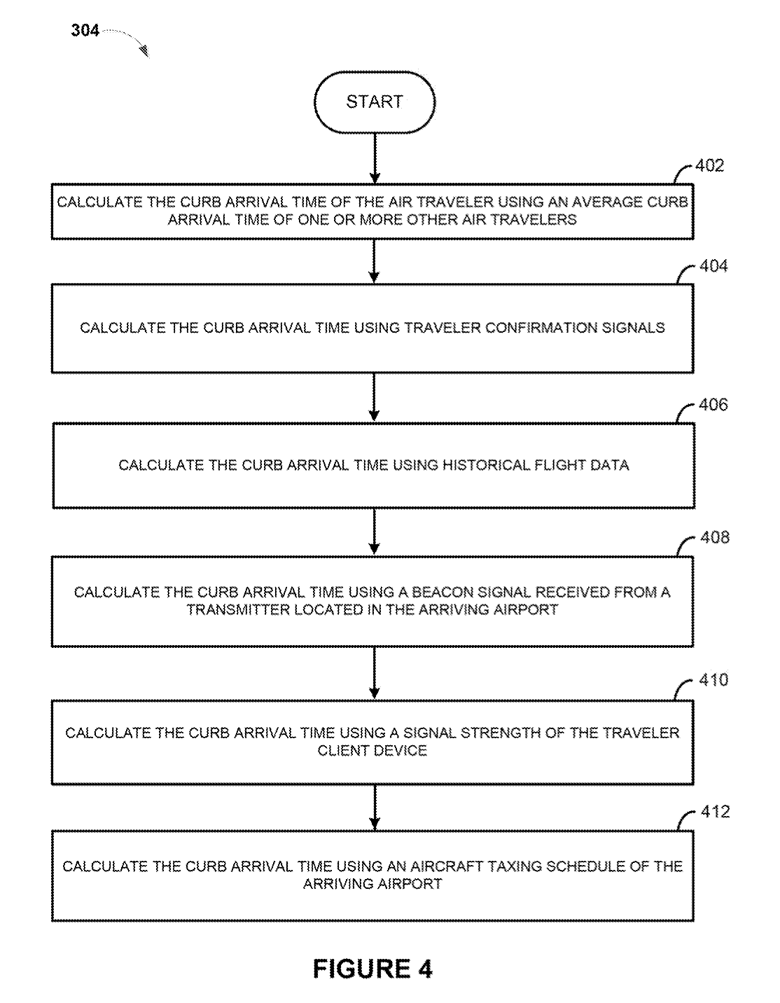

FIG. 4 illustrates step 304 of the method 300 of operation of the system 100. Step 304 can include calculating the curb arrival time 504 of the air traveler 101 using an average curb arrival time one or More other air travelers in a step 402. The other air travelers can be fellow passengers on the same aircraft as the air traveler 101. The average curb arrival time can be calculated by taking a mean or median of the actual or estimated curb arrival times of the other air travelers.

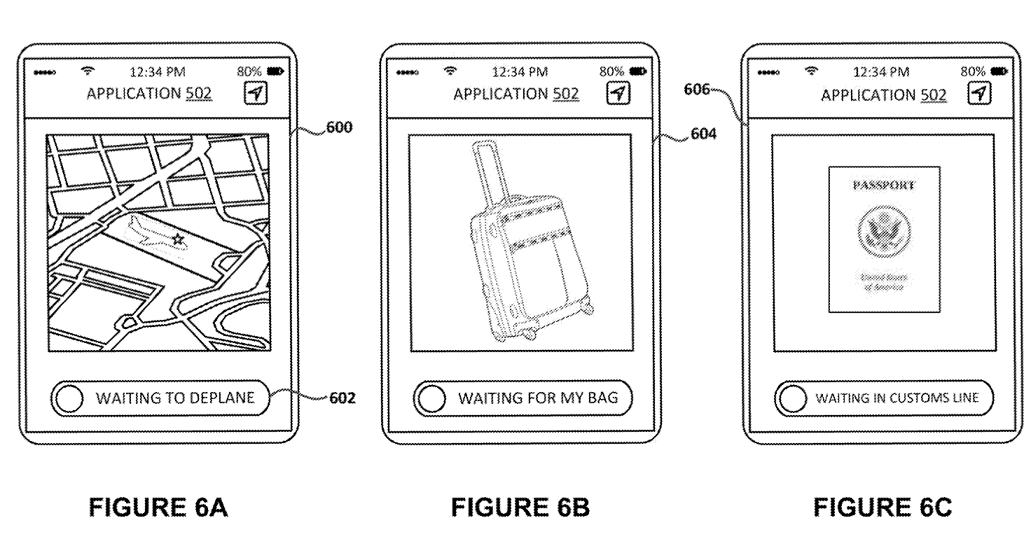

Step 304 can also include calculating the curb arrival time 504 of the air traveler 101 using traveler confirmation signals 602 (see FIG. 6) received from the traveler client device 104 in a step 404. The traveler confirmation signals 602 will be discussed in more detail in FIG. 6.

Step 304 can also include calculating the curb arrival time 504 using historical flight data in a step 406. Historical flight data can refer to data or information concerning flight patterns, flight arrival times, flight delays, airport delays, or a combination thereof. In one embodiment, historical flight data can be retrieved from an air traffic database. In another embodiment, historical flight data can be retrieved from a flight tracking service such as FlightAware™.

Step 304 can also include calculating the curb arrival time 504 using beacon signals 116 received from transmitters 118 located in the arriving airport 120 in a step 408. For example, the server 102 can track the progress of the air traveler 101 through the arriving airport 120 based on the beacon signals 116 triggered by the traveler client device 104 carried by the air traveler 101. As a more specific example, a transmitter 118 can emit periodic beacon signals 116 to all devices in the vicinity of the transmitter 118. The transmitter 118 can send a tracking signal to the server 102 when the transmitter 118 receives a ping reply or an echo reply from the traveler client device 104 in response to the beacon signals 116.

Step 306 can include calculating the curb arrival time 504 using a signal strength 506 (see FIG. 5) of the traveler client device 104 in a step 410. The server 102 can track the progress of the air traveler 101 through the arriving airport 120 based on changes or a differential in the signal strength 506 of the traveler client device 104. The traveler client device 104 can periodically or continuously transmit the signal strength 506 of the traveler client device 104 to the server 102. The signal strength 506 can include a cellular signal strength such as a 3G signal strength, a 4G signal strength, or an LTE signal strength, a WiFi connection strength, or a combination thereof. The server 102 can use the changes in the signal strength 506 of the traveler client device 101 to estimate the progress of the air traveler 101 through different sections or regions of the arriving airport 120. For example, the signal strength 506 of the traveler client device 101 can be low or barely connected when the air traveler 101 is in a bathroom, changing room, airport lounge, or exercise room of the arriving airport 120. Alternatively, the signal strength 506 of the traveler client device 101 can be high or at full strength when the air traveler 101 is near a gate or entrance of the arriving airport 120.

Step 306 can also include calculating the curb arrival time 504 of the air traveler 101 using an aircraft taxing schedule of the arriving airport 120 in a step 412. The server 102 can receive or retrieve the aircraft taxing schedule from an air traffic controller or air traffic control system of the arriving airport 120.

FIG. 5 illustrates an embodiment of a transportation booking graphical user interface (GUI) 500 displayed on the traveler client device 104. The booking GUI 500 can be rendered through an application 502. In one embodiment, the application 502 can be written in the Xcode™ programming language. In another embodiment, the application 502 can be written in the Swift™ programming language. In other embodiments, the application 502 can be written using the Java™ programming language, the Objective-C programming language, or a C programming language.

The air traveler 101 can open the application 502 and apply a user input to one or more buttons or links confirming an intent of the air traveler 101 to arrange for ground transportation when the air traveler 101 at a curb of the arriving airport 120. The curb can be a curb outside an arrival terminal of the arriving airport 120. It should be understood by one of ordinary skill in the art of transportation logistics that the term “curb” is not limited to a physical street-side curb but any location accessible to a mode of transportation offering pick up or drop-off services.

As can be seen in FIG. 5, the air traveler 101 can enter a flight number, an airline name or ID, a flight confirmation code, or a combination thereof through the booking GUI 500 of the application 502. The traveler client device 104 can then transmit this information to the server 102 through the network 108. When the aircraft 112 transporting the air traveler 101 is in flight and out of reach of terrestrial communication satellites or stations, the traveler client device 104 can connect to the server 102 through the on-board WiFi network of the aircraft 112.

FIG. 6A illustrates an embodiment of a traveler deplaning GUI 600 displayed on the traveler client device 104. The air traveler 101 can apply a user input to a button or link of the application 502 to instruct the traveler client device 104 to send a traveler confirmation signal 602 to the server 102. For example, when the aircraft 112 carrying the air traveler 101 has landed at the arriving airport 120, the air traveler 101 can apply a user input to a “Waiting to Deplane” button of the deplaning GUI 600 to inform the server 102 that the air traveler 101 is currently waiting to deplane the aircraft 112.

FIG. 6B illustrates an embodiment of a baggage claim GUI 604 displayed on the traveler client device 104. The air traveller 101 can apply a user input to a button or link displayed on the baggage claim GUI 604 to instruct the traveler client device 104 to send another traveler confirmation signal 602 to the server 102. For example, the air traveler 101 can apply a user input to a “Waiting for My Bag” button of the baggage claim GUI 604 to inform the server 102 that the air traveler 101 is currently waiting for luggage at the baggage claim of the arriving airport 120.

FIG. 6C illustrates an embodiment of a customs GUI 606 displayed on the traveler client device 104. The air traveler 101 can apply a user input to a button or link displayed on the customs GUI 606 to instruct the traveler client device 104 to send another traveler confirmation signal 602 to the server 102. For example, the air traveler 101 can apply a user input to a “Waiting in Customs Line” button of the customs GUI 606 to inform the server 102 that the air traveler 101 is currently waiting in a customs line at the arriving airport 120. The server 102 can then use the various traveler confirmation signals 602 received from the traveler client device 104 to track the progress of the air traveler 101 through the arriving airport 120. The server 102 can use information concerning the real-time location of the air traveler 101 to calculate the curb arrival time 504 of the air traveler 101 using an arrival estimation algorithm.

Although FIGS. 3, 4A, 4B, and 4C of the present disclosure show a standalone mobile application, it should be understood by one of ordinary skill in the art that the methods disclosed herein can also be implemented as a software development kit (SDK) configured to be integrated into the code stack of a mobile or web platform. For example, the methods disclosed herein can be implemented as executable code configured to be integrated into the code stack of a ride-sharing platform or service.

The system 100 and methods described herein provides improvements in predicting the curb arrival time of air travelers debarking from an aircraft. In addition, the system 100 and methods described herein provides improvements in arranging ground transportation for a debarking air traveler based on the curb arrival time of the debarking air traveler. The system 100 and methods described herein also provides improvements in how mobile client devices can be used as a passenger or traveler location tracking device. For example, by installing the application 300, the mobile client device 106 such as a mobile phone, tablet, or smartwatch, can automatically act as a traveler location tracking device for interacting with the server 102.

A number of embodiments have been described. Nevertheless, it will be understood by one of ordinary skill in the art that various modifications may be made without departing from the spirit and scope of the embodiments. In addition, the flowcharts or logic flows depicted in the figures do not require the particular order shown, or sequential order, to achieve desirable results. In addition, other steps or operations may be provided, or steps or operations may be eliminated, from the described flows, and other components may be added to, or removed from, the described systems. Accordingly, other embodiments are within the scope of the following claims.

It will be understood by one of ordinary skill in the art that the various methods disclosed herein may be embodied in a non-transitory readable medium, machine-readable medium, and/or a machine accessible medium comprising instructions compatible, readable, and/or executable by a processor or processing unit of a machine, device, or computing device. The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

We claim:

1. A system to arrange ground transportation for an air traveler, comprising:
a server comprising a processing unit coupled to a memory unit and a server communication unit, wherein the processing unit is programed to:
receive GPS coordinates from at least one of a GPS unit of a traveler client device, a position fix from an onboard radio of the traveler client device, and an in-flight locational unit of an aircraft carrying the air traveler;
calculate a curb arrival time of the air traveler using an arrival estimation algorithm, wherein the arrival estimation algorithm uses as an input at least one of the GPS coordinates, an aircraft landing signal, and a map of an arriving airport; and
transmit the curb arrival time of the air traveler to at least one of a ride-sharing server and a driver client device.

2. The system of claim 1, wherein the processing unit of the server is configured to calculate the curb arrival time of the air traveler using an average curb arrival time of one or more other air travelers

3. The system of claim 1, wherein the GPS coordinates are received in response to a user input applied to a display of an inflight seatback console.

4. The system of claim 1, wherein the in-flight locational unit provides the GPS coordinates through an AIRINC 429 data transfer protocol.

5. The system of claim 1, wherein the processing unit is programmed to receive traveler confirmation signals from the traveler client device arid calculate the curb arrival time using the traveler confirmation signals as additional inputs.

6. The system of claim 1, wherein the processing unit is programmed to calculate the curb arrival time using historical flight data.

7. The system of claim 1, wherein the processing unit is programmed to calculate the curb arrival time using a beacon signal received from a transmitter located in the arriving airport, a radio triangulation signal, a hotspot identification signal, and a sensor data from an inertial measurement unit of the traveler client device.

8. The system of claim 1, wherein the aircraft landing signal includes at least one of an aircraft weight-on-wheels hardware discrete read, an aircraft door-open hardware discrete read, and an aircraft parking brake discrete read.

9. The system of claim 1, wherein the processing unit is programmed to calculate the curb arrival time using, a signal strength of the traveler client device received from the traveler client device as an additional input.

10. The system of claim 1, wherein the processing unit is programmed to calculate the curb arrival time using an aircraft taxing schedule of the arriving airport as an additional input.

11. A non-transitory machine readable medium comprising instructions stored thereon, wherein the instructions are executable by a processing unit and include the steps comprising:
receiving, at a server comprising the processing unit, GPS coordinates from at least one of a GPS unit of a traveler client device, a position fix from an onboard radio of the traveler client device, and an in-flight locational unit of an aircraft carrying the air traveler;
calculating, at the server, a curb arrival time of the air traveler using an arrival estimation algorithm, wherein the arrival estimation algorithm uses as an input at least one of the GPS coordinates, an aircraft landing signal, and a map of an arriving airport; and
transmitting, from the server, the curb arrival time of the air traveler to at least one of a ride-sharing server and a driver client device.

12. The non-transitory readable medium of claim 11, further comprising instructions including the step of calculating the curb arrival time of the air traveler using an average curb arrival time of one or more other air travelers.

13. The non-transitory readable medium of claim 11, wherein the GPS coordinates are received in response to a user input applied to a display of an inflight seatback console.

14. The non-transitory readable medium of claim 11, wherein the in-flight locational unit provides the GPS coordinates through an AIRINC 429 data transfer protocol.

15. The non-transitory readable medium of claim 11, further comprising instructions including the steps of:
receiving traveler confirmation signals from the traveler client device; and
calculating the curb arrival time using the traveler confirmation signals as additional inputs.

16. The non-transitory readable medium of claim 11, further comprising instructions including the step of calculating the curb arrival time using historical flight data.

17. The non-transitory readable medium of claim 11, further comprising instructions including the step of calculating the curb arrival time using a beacon signal received from a transmitter located in the arriving airport, a radio triangulation signal, a hotspot identification signal, and a sensor data from an inertial measurement unit of the traveler client device.

18. The non-transitory readable medium of claim 11, wherein the aircraft landing signal includes at least one of an aircraft weight-on-wheels hardware discrete read, an aircraft door-open hardware discrete read, and an aircraft parking brake discrete read.

19. The non-transitory readable medium of claim 11, further comprising instructions including the step of calculating the curb arrival time using a signal strength of the traveler client device received from the traveler client device as an additional input.

20. The non-transitory readable medium of claim 11, further comprising instructions including the step of calculating the curb arrival time using an aircraft taxing schedule of the arriving airport as an additional input.
